(19) United States
(12) Patent Application Publication
(10) Pub. No.: US 2026/0370654 A1
(43) Pub. Date: Nov. 19, 2026

(54) ENHANCED LOCATION MATCHING

(71) Applicant: Google LLC, Mountain View, CA (US)

(72) Inventors: YaoShuang Wang, Belmont, MA (US); Walter Alejandro Vulej, Mountain View, CA (US); Kalluri Eswar, Cupertino, CA (US); Li Zou, Fremont, CA (US); Usama Sarwar, Santa Clara, CA (US)

(21) Appl. No.: 19/416,782

(22) Filed: Dec. 11, 2025

Related U.S. Application Data
(60) Provisional application No. 63/807,026, filed on May 16, 2025.

(51) Int. Cl. H04L 9/40

(52) U.S. Cl. CPC H04L 63/107; H04L 63/102; H04L 63/104

(57) ABSTRACT

Methods, systems, and apparatus, including computer programs encoded on a computer storage medium, for disambiguating location information and distributing digital components based on the location information. In one aspect, a method includes receiving, for a content distribution account that includes a set of digital components, distribution parameters for the set of digital components. The distribution parameters include account-level distribution parameters that include account-level location criteria for the set of digital components and account group-level distribution parameters that include, for each of multiple subsets of digital components of the set of digital components, account group-level location criteria. A digital component request comprising one or more terms is received from a client device. A determination is made that the digital component request includes an area of interest. In response to determining that the digital component request comprises an area of interest, a set of candidate digital components is identified.

### CROSS-REFERENCE TO RELATED APPLICATION

This application claims the benefit under 35 U.S.C. § 119(e) of U.S. Patent Application No. 63/807,026, entitled “PRECISE LOCATION MATCHING,” filed on May 16, 2025. The disclosure of the foregoing application is incorporated herein by reference in its entirety for all purposes.

### BACKGROUND

Keywords are often used to define geographic locations for specifying constraints or filters for various use cases. Absent other signals, a keyword may not accurately express the location intent as there may be many cities with the same name or areas that do not have clear names that can be specified using a keyword.

### SUMMARY

In general, one innovative aspect of the subject matter described in this specification can be embodied in methods that include the actions of receiving, for a content distribution account comprising a set of digital components, distribution parameters for the set of digital components, wherein the distribution parameters comprise account-level distribution parameters comprising account-level location criteria for the set of digital components and account group-level distribution parameters comprising, for each of multiple subsets of digital components of the set of digital components, account group-level location criteria; receiving, from a client device, a digital component request comprising one or more terms; determining that the digital component request comprises an area of interest; in response to determining that the digital component request comprises an area of interest, identifying a set of candidate digital components, including identifying, as a candidate digital component, at least one digital component in the set of digital components for which the area of interest satisfies the account group-level location criteria for a subset of digital components that includes the at least one digital component; selecting, from the set of candidate digital components, one or more digital components to provide to the client device in response to the digital component request; and sending the one or more digital components to the client device. Other implementations of this aspect include corresponding apparatus, systems, and computer programs, configured to perform the aspects of the methods, encoded on computer storage devices.

These and other embodiments can each optionally include one or more of the following features. Some aspects include receiving, from an additional client device, an additional digital component request comprising one or more additional terms; determining that the additional digital component request does not include an area of interest; and in response to determining that the additional digital component request does not include an area of interest, determining whether the additional digital component request indicates a location of presence of the additional client device.

Some aspects include, in response to determining that the additional digital component request indicates the location of presence of the additional client device: identifying an additional set of candidate digital components, including identifying, as an additional candidate digital component, at least one additional digital component in the set of digital components for which the location of presence satisfies both the account-level location criteria and the account group-level location criteria for a subset of digital components that includes the at least one additional digital component; selecting, from the additional set of candidate digital components, one or more additional digital components to provide to the additional client device in response to the additional digital component request; and sending the one or more additional digital components to the additional client device.

Some aspects include, in response to determining that the additional digital component request does not indicate the location of presence of the additional client device: identifying an additional set of candidate digital components, including identifying, as an additional candidate digital component, at least one digital component in the set of digital components that does not have location-based distribution parameters; selecting, from the additional set of candidate digital components, one or more additional digital components to provide to the additional client device in response to the additional digital component request; and sending the one or more additional digital components to the additional client device.

In some aspects, determining that the digital component request comprises an area of interest comprises determining that the digital component request comprises an area of interest based at least on the one or more terms.

In some aspects, determining that the digital component request comprises an area of interest comprises disambiguating between multiple geographic areas based on one or more additional signals, the one or more additional signals comprising a location of presence of the client device.

In some aspects, the one or more additional signals comprise historical locations of the client device and/or a user of the client device.

In some aspects, the one or more additional signals comprise, for each historical location a frequency at which the client device or the user of the client device has visited the historical location.

In some aspects, determining that the digital component request comprises an area of interest comprises determining that the digital component request comprises an area of interest based at least on (i) the one or more terms, (ii) location history of the user, (iii) past searches of the user, or any combination of (i), (ii), and (iii).

Particular embodiments of the subject matter described in this specification can be implemented so as to realize one or more of the following advantages. The techniques described in this document enable entities to define location intents (e.g., in the form of location criteria) on multiple levels to enable more precise and fine-grained location matching and filtering in various use cases. This enables faster and more efficient location-based content selection by comparing the criteria, which can be in the form of identifiers (IDs) to location information of queries or requests for content. Disambiguation techniques described in this document enable a system to more accurately determine the area of interest such that the matching or filtering can also be performed more accurately. The disambiguation techniques can include evaluating multiple different signals including any location terms to accurately determine the geographic area that best satisfies the user’s informational needs or that is most likely to be of interest to the user.

This ensures that the system provides the most relevant content to the user based on the correct location information. By providing the most relevant content, the computational resources of the system are used more efficiently. For example, absent the described techniques, the user may receive content related to a completely different location than the one intended. Such a user would have to refine their query in an attempt to obtain the correct information or fail to detect the information is irrelevant and interact with the content, causing additional irrelevant content delivery that wastes computing and networking resources. Refinements result in additional network traffic between the user’s device and the content system and additional processing of the refined query to identify information to provide in response to the refined query, which inefficiently consumes network bandwidth and computational resources that could be used to transmit other data and/or perform other tasks. When the user fails to detect the information is irrelevant, their interactions with irrelevant information waste their time, as well as causing wasted time and expense for the digital component providers who may expend resources for interactions and who spend time, e.g., qualifying leads, with the wrong interest. Thus, the described techniques more efficiently use network and computation resources compared to other techniques for identifying the location intent of a query or request.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which digital components are distributed to client devices.

FIG. 2 is an illustration of an example interactive interface for selecting a location for a digital component.

FIG. 3 is a flow chart of an example process of selecting a digital component based on location information and sending the digital component to a client device.

FIG. 4 a block diagram of an example computer.

Like reference numbers and designations in the various drawings indicate like elements.

### DETAILED DESCRIPTION

This specification describes techniques for disambiguating location information and distributing digital components based on the location information. The systems and techniques described in this document enable digital component providers to specify location-based criteria in the form of distribution parameters for digital components at multiple levels, e.g., at a content distribution account level for a set of digital components in a content distribution account and at an account group level for a subset of the digital components, which facilitates more precise and flexible location criteria for digital components. The system can disambiguate location signals of a digital component request and identify digital components having distribution parameters for which the disambiguated location information satisfies the location-based criteria for the digital components.

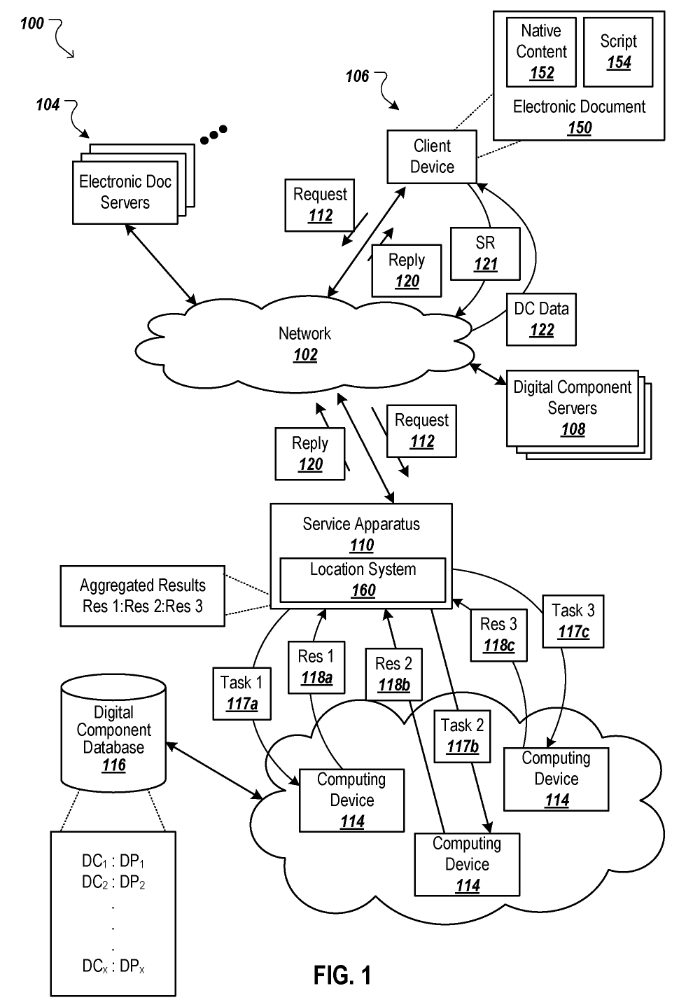

FIG. 1 is a block diagram of an example environment 100 in which digital components are distributed to client devices 106. The example environment 100 includes a network 102, such as a local area network (LAN), a wide area network (WAN), the Internet, or a combination thereof. The network 102 connects electronic document servers 104, client devices 106, digital component servers 108, and a service apparatus 110. The example environment 100 may include many different electronic document servers 104, client devices 106, and digital component servers 108.

The service apparatus 110, which can be implemented as one or more computers in one or more locations, is configured to provide various services to client devices 106, publishers of electronic documents 150, and/or digital component providers that provide digital components to client devices 106, e.g., using the service apparatus 110. In some implementations, the service apparatus 110 can provide search services by providing responses to search queries received from client devices 106. For example, the service apparatus 110 can include a search engine and/or an AI agent or other chat agent that enables users to interact with the agent over the course of conversational queries and responses. The service apparatus 110 can also distribute digital components to client devices 106 for presentation with the responses and/or with electronic documents 150. For example, another search service computer system can send component requests 112 to the service apparatus 110 and these component requests 112 can include one or more queries. In another example, client devices 106 can send component requests 112 to the service apparatus 110, e.g., in response to loading an electronic document 150 that includes a digital component slot for presenting a digital component, as described in more detail below.

As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

A client device 106 is an electronic device capable of requesting and receiving online resources over the network 102. Example client devices 106 include personal computers, gaming devices, mobile communication devices, digital assistant devices, augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic document server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server’s execution of the app and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested, e.g., contextual data that describes an environment in which a digital component will be presented, and characteristics of locations of the electronic document at which the digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document.

The event data can also include a search query that was submitted from the client device 106 to obtain a search results page or a response in a conversational user interface. For example, an AI agent or other form of a chat agent can provide a conversational user interface in which users can provide natural language queries, which can be in the form of prompts for a language model and receive responses to the queries. The user can refine their expression of their informational needs as the conversation progresses and the AI agent can send component requests 112 with the updated queries.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

Delays in providing digital components in response to a component request 112 can result in page load errors at the client device 106 or cause portions of the electronic document to remain unpopulated even after other portions of the electronic document are presented at the client device 106. Also, as the delay in providing the digital component to the client device 106 increases, it is more likely that the electronic document will no longer be presented at the client device 106 when the digital component is delivered to the client device 106, thereby negatively impacting a user’s experience with the electronic document. Further, delays in providing the digital component can result in a failed delivery of the digital component, for example, if the electronic document is no longer presented at the client device 106 when the digital component is provided. The described techniques are adapted to disambiguate location signals of a component request 112 and select and provide digital components in a short amount of time such that these errors and user experience impact are reduced or eliminated.

In some implementations, the service apparatus 110 is implemented in a distributed computing system that includes, for example, a server and a set of multiple computing devices 114 that are interconnected and identify and distribute digital components in response to requests 112. The set of multiple computing devices 114 operate together to identify a set of digital components that are eligible to be presented in the electronic document from among a corpus of millions of available digital components (DC₁₋ₓ). The set of digital components can include customizable digital components. The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, and/or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can specify dates, days of the week, and/or times at which the digital component is eligible for presentation.

The distribution parameters can specify an eligibility value or selection value (e.g., ranking score, or some other specified value) that is used for evaluating the eligibility of the digital component for distribution/transmission (e.g., among other available digital components). The selection value can indicate an amount (e.g., a monetary amount) that a digital component provider is willing to provide to publisher for the digital component to be presented with a resource of the publisher. The distribution parameters can specify different selection values based on other distribution parameters, e.g., based on keywords, geographic location, time of day, day of week, date, etc.

The distribution parameters can require that the component request 112 include information, e.g., as event data, specifying a particular geographic region (e.g., country or state) and/or information specifying that the component request 112 originated at a particular type of client device (e.g., mobile device or tablet device) in order for the digital component to be eligible for presentation. Location-based criteria of distribution parameters are described in more detail below.

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106. If a customizable digital component is a winning digital component, the service apparatus 110 can generate a new digital component using the selected assets and layout for the customizable digital component prior to sending the new digital component to the client device 106. In some implementations, the client device 106 executes instructions included in the reply data 120, which configures and enables the client device 106 to obtain the set of winning digital components from one or more digital component servers 108. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit to the client device 106, digital component data (DC Data) 122 that presents, or enables presentation of, the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlayed over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

The service apparatus 110 can also include a location system 160 that determines whether digital components are eligible based on location-based criteria of distribution parameters of the digital components. The service apparatus 110 can enable digital component providers to specify or otherwise provide location-based criteria at the account level for a set of digital components and at the account group level for a subset of the digital components in the set of digital components. For example, digital components in a content distribution account may be eligible to be provided to users interested in receiving products or services in the United States, while subsets of these digital components may only be eligible to be provided to users interested in receiving products or services in specific areas of the United States. As another example, a user at work in Boston may search for “plumbers in Salem MA (e.g., because they have a need at home in Salem). The location of interest for the user is Salem rather than Boston.

The service apparatus 110 enables digital component providers to create content distribution accounts and provide digital components for distribution for the account. The service apparatus 110 also enables the digital component providers to specify distribution parameters at the account level and at the account group-level for one or more account groups that each include a subset of the digital components in the account. The account-level distribution parameters can apply to all digital components in the account. The account group-level distribution parameters can apply to digital components in the subset of digital components in that account group. The service apparatus 110 can enable the digital component providers to select the digital components for each of their account groups and to specify the distribution parameters, including location criteria, at both levels.

In general, a content distribution account of a digital component provider can include a set of digital components that include content about a common subject and/or that are distributed according to a common or similar strategy. For example, a content distribution account can include digital components that include content related to concerts. In this example, the account level location criteria can limit the eligibility of the set of digital components in the content distribution account to users that are interested in attending the concert in the specific cities in which the concert will occur. In addition, the digital components for each region can have different content such that there are subsets of digital components for each region. Each subset of digital components can have account group level location criteria that limits their eligibility to their regions.

In some cases, digital component distribution systems have limited location-based criteria to the account level, which required digital component providers to set up multiple content distribution accounts to distribute different digital components to different geographic areas or to attempt to specify the areas using keywords. Keyword-based matching can lead to errors in identifying the appropriate location as many cities have the same names or match brand or descriptive names of items (e.g., Chicago pizza) for which the keywords were intended to match. This leads to errors in providing irrelevant digital components that do not satisfy the users’ informational needs, which wastes computing and network resources in sending irrelevant digital components. This also wastes the resources of the digital component providers that may expend resources, e.g., money and time, to send the digital components to users that are not interested in the digital components.

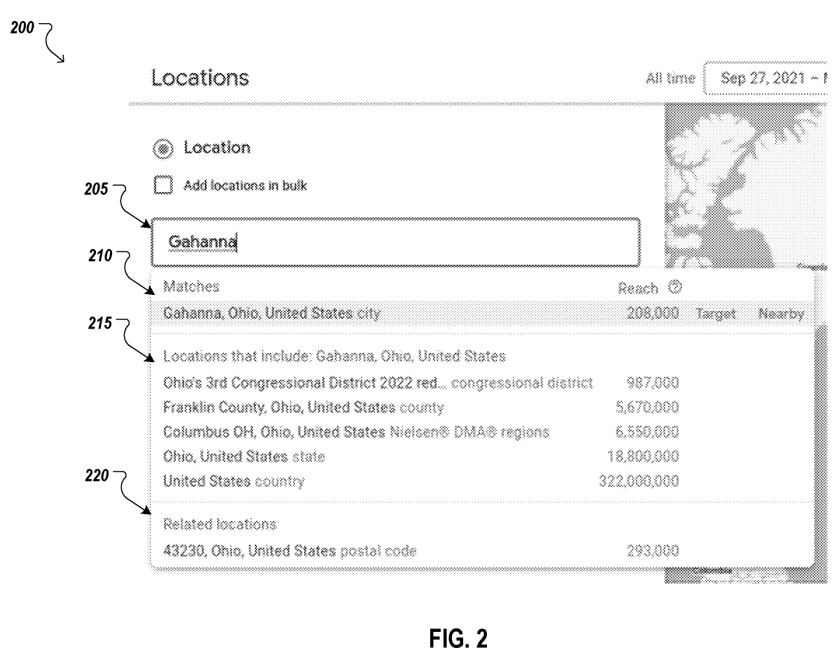

The location system 160 and/or the service apparatus 110 can generate, provide, and/or update user interfaces that enable digital component providers to provide location-based criteria at the account level and account group level. An example user interface is shown in FIG. 2 and described below.

In some implementations, the location system 160 can determine location criteria for a content distribution account and/or account groups in the content distribution account based on information about the content distribution account and/or information about the subset of digital components. For example, the location system 160 can use one or more artificial intelligence (AI) models, e.g., one or more machine learning models, to evaluate the information to determine the locations that are relevant to the content distribution account or account group. The information can include an item that is the subject of the content distribution account or account group, a landing page linked to the digital component(s), information about the digital component provider, the digital component(s) themselves, and/or other relevant information.

The location system 160 can enable the digital component providers to specify different types of interest matching for a content distribution account and/or for account groups in the content distribution account. One type of matching is area of interest matching. In area of interest matching, a digital component is eligible when the area of interest of a component request 112, if any, satisfies the area of interest location criteria for the account group and/or its content distribution account. The area of interest of a component request 112 can represent an interest in a given geographic location that is determined or predicted based on the event data of the component request 112. For example, the area of interest can indicate an interest of a user of a client device 106 from which a content request is received, which can differ from the user’s current location. For example, the event data of content request 112 includes the keyword “Atlanta” (e.g., as a query term or term from an electronic document with which a selected digital component will be presented), the location system 160 can predict that the user is interested in content in the area of Atlanta.

The location system 160 can determine or at least predict the location of interest based on the event data of a component request 112 and any other data included with a component request 112. The location system 160 can evaluate keywords (e.g., query terms or electronic document terms) to infer the area of interest. For example, if a user is interested in information or other content in a particular geographic area, especially when that area is different from their current location, the user will often include the location in a query. In this example, the location system 160 can extract the area of interest directly from the keywords of the event data. If the user does not specify a location, multiple signals can be used to infer where the user is likely to be interested in. Even if the user’s search term mentions a location, multiple signals will be used to disambiguate names, e.g., if the user searches for “hotels in Cambridge”, multiple signals will be used to disambiguate whether they’re interested in “hotels in Cambridge, MA, USA” or “hotels in Cambridge, UK”.

The location system 160 can evaluate contextual information in the content request 112, e.g., if there is no location keyword in the event data of the component request 112. For example, the keywords can include a landmark or facility that is known to be in a particular geographic location. In this example, the location system 160 can predict that the user is interested in the geographic location that has that landmark or facility and set the area of interest for the component request 112 to that geographic location.

Users often submit queries that include the text “near me” or similar text when searching for something in or near their current location. In such examples, the location system 160 can predict that the user is interested in their current location and/or locations within a threshold distance of the current location and set the area of interest for the component request 112 to those locations if the current location is known or can be disambiguated using other signals (e.g., IP address of the client device 106).

The location system 160 can use other signals to disambiguate from multiple possible areas of interest. For example, the keywords of a query can include the name of a city or facility for which multiple cities or facilities are named. The location system 160 can use contextual signals or other event data of a component request 112 and/or device location information to disambiguate between the multiple possible areas of interest. For example, if a keyword of the component request 160 includes the name of something in a given area and one area of interest is in or near that area, the location system 160 can predict that the user is interested in that area instead of other possible areas of interest indicated by the keywords. In another example, the location of the client device 106 can be more proximal to one of the areas of interest and, if close enough (e.g., within a threshold distance), the location system 160 can set the area of interest for the component request 112 to that location.

In some implementations, the location system 160 can use historical location information of a user and/or the user’s client device 106 to disambiguate between multiple possible areas of interest, if permitted by the user. The location system 160 can use the frequency at which the user or client device 106 has been in each of multiple locations and/or the amount of time spent in each location to disambiguate between multiple possible areas of interest. For example, if there are two possible areas of interest for a component request 112 for a user and the user has been to a first area of the two areas more times than the second area, the location system 160 can set the area of interest for the component request 112 to the first area. The location system 160 can also use known addresses (e.g., residence or work) of the user to disambiguate between multiple possible areas of interest, if permitted by the user.

The location system 160 can use the search history of the user to disambiguate between multiple possible areas of interest. For example, the location system 160 can use location terms or other location signals in previous queries of the user to disambiguate between multiple locations.

The location system 160 can use any combination of these example signals to disambiguate between multiple possible areas of interest for a component request 112.

Another type of matching is location of presence matching. In location of presence matching, a digital component is eligible when the location of presence, if any, of a component request 112 satisfies the location of presence criteria for account group that includes the digital component and/or its content distribution account. The location of presence of a component request 112 can indicate the geographic location of the client device 106 that sent the component request 112. For example, the location of presence of a component request 112 can indicate the location of the client device 106 when the component request 112 was sent.

In some cases, the location of a client device 106 can be part of the event data or otherwise included with (e.g., as metadata of) a component request 112. This location can be broad (e.g., at the city or zip code level) to protect user privacy. In some implementations, the location system 160 is configured to determine or predict the location of presence based on signals of the content request, e.g., based on the event data and/or metadata or other data of the component request 112. For example, the location system 160 can be configured to determine the location of a client device 106 by triangulating mobile phone tower data for the client device 106 or using an IP address of the component request 112. However, use of any data indicating a geographic location of a client device 106 of a user can be controlled by that user.

For situations in which the systems discussed here collect and/or use personal information about users, the users may be provided with an opportunity to enable/disable or control programs or features that may collect and/or use personal information (e.g., information about a user’s preferences or a user’s current location). In addition, certain data may be treated in one or more ways before it is stored or used, so that personally identifiable information associated with the user is removed. For example, a user’s identity may be anonymized so that the no personally identifiable information can be determined for the user, or a user’s geographic location may be generalized where location information is obtained (such as to a city, ZIP code, or state level), so that a particular location of a user cannot be determined.

A digital component can specify one or multiple types of matching at the account level and/or at the account group level, and the types of matching can be the same or different. For example, a content distribution account can include location of presence matching criteria while at least one account group in the content distribution account has area of interest matching criteria. Similarly, a content distribution account can include area of interest matching criteria while at least one account group in the content distribution account has location of presence matching criteria. The content distribution account can also have both types of matching and account groups in the content distribution account can have none, one, or both types. In another example, the content distribution account can have neither type of location matching while account groups in the content distribution account can have none, one, or both types of matching. If both types of matching are specified for a content distribution account or account group, the component request 112 may have to satisfy both criteria to be eligible to be provided in response to the component request 112. In some other cases, the account level location criteria can be a fallback in cases in which an area of interest cannot be determined or predicted for a component request 112.

To identify candidate digital components for a component request 112, the location system 160 can evaluate the location criteria of content distribution account and account groups in the content distribution account, along with other distribution parameters. For example, the location system 160 can identify, as the candidate digital components, each digital component for which all distribution parameters are satisfied.

In some implementations, the location for the component request 112 does not have be an exact match to the location criteria. For example, if the area of interest criteria for a content distribution account specifies the city of Atlanta and the area of interest of a component request indicates a suburb of Atlanta, the digital components of the content distribution account may be eligible based on proximity to Atlanta. For example, the location system 160 can enable digital components to be eligible if the locations are within a threshold distance from each other or known to be near each other.

In some implementations, the location system 160 can require an exact match between location criteria and a location of a component request 112 for either area of interest matching or location of presence matching. The location system 160 can enable the digital component provider to select between exact and broad matching for each matching type separately to provide more flexibility.

The location system 160 can prioritize one type of matching over another, e.g., based on default rules or settings specified by the digital component provider. For example, a content distribution account can have both area of interest and location of presence criteria. Depending on various factors, component requests 112 can include no location information, only area of interest information, only location of presence information, or both area of interest information and location of presence information. As area of interest can often be more difficult to detect compared to presence, a digital component provider can specify location of presence criteria as a backup in cases in which the area of interest for a component request 112 cannot be determined.

In situations in which a content distribution account or account group has both area of interest and location of presence criteria, the location system 160 can prioritize the area of interest criteria. If the component request 112 has an area of interest and a location of presence, the location system 160 can be configured to determine whether the area of interest of the content distribution account satisfies the area of interest criteria of the content distribution account. If not, the digital components of the content distribution account may not be eligible even if the location of presence of the component request 112 satisfies the location of presence criteria of the content distribution account.

In another example, the location system 160 can be configured to only evaluate location of presence criteria when an area of interest cannot be determined or predicted for a component request 112. If the area of interest satisfies the account group level location criteria for an account group, the digital components of that account group may be eligible as candidate digital components. If there is no area of interest, the digital components of the content distribution account may be eligible if the location of presence of the component request satisfies the account level location criteria for the content distribution account.

In other examples, the location system 160 can enable both types of matching to be considered, e.g., based on a selection of the digital component provider for the content distribution account. For example, a digital component provider may want to have its digital components shown to users in a first location (using location of presence matching) that are interested in information or content in a second location different from the first location (using area of interest matching). In this example, the location system 160 would evaluate both types of criteria against the location(s) of the component request 112 to determine whether the digital components of the content distribution account are eligible. To be eligible, the component request 112 would need to have both types of location information and both types of location information would have to satisfy its corresponding location criteria.

In some implementations, the account group level location criteria is prioritized over the account level location criteria and/or the account level location criteria may only be used when there is no account group level location criteria. For example, if the digital component provider specified location criteria at the account group level for one or more digital components, those digital components may only be eligible when that criteria is satisfied independent of whether the account group location criteria is satisfied. In a particular example, the account level location criteria may be the United States, while the account group level location criteria for a digital component may be Nevada. In this example, the digital component may only be eligible if the location of interest or location of presence (depending on the type of criteria specified) is Nevada. Thus, the digital component would not be eligible for a component request having a location of interest or location of presence of New York although New York satisfies the account level location criteria.

FIG. 2 is a block diagram of an example interactive interface 200 for selecting a location for a digital component. The interface 200 can be used to select account level location criteria for a set of digital components that are part of a content distribution account and/or account group level location criteria for a subset of the set of digital components.

The interface 200 includes a location entry field 205 that enables a user to enter a location, e.g., by typing in the name of the location. The interface 200 also includes a matching element 210 that shows a matching location (e.g., city, county, state, etc.) that is determined to match the text entered by the user in the location entry field 205. For example, the location system 160 can attempt to match partial entries (e.g., incomplete entries while the user types) to known locations and, if a match is found, show the matching location in the matching element 210. If the matching location is the desired location of the user, the user can select the location in the matching element 210 and the location system 160 can add the location as location-based criteria for the content distribution account or subset of digital components for which criteria is being specified.

The interface 200 also includes a broad match area 215 that shows locations that include the matching location shown in the matching element 210. Similar to the matching element, the user can select a location in the broad match area 215 and the location system 160 can add the location as location-based criteria for the content distribution account or account group for which criteria is being specified.

The interface 200 also includes a related locations area 220 that shows related locations that are considered to be related to the matching location shown in the matching element 210. Similar to the matching element 210, the user can select a location in the related locations area 220 and the location system 160 can add the location as location-based criteria for the content distribution account or subset of digital components for which criteria is being specified.

The interface 200 makes it easy for users to add precise location criteria to content distribution accounts and account groups without having to rely on ambiguous keywords, and to identify other locations that may be of interest. Additionally, by using actual locations selected by a user, the location system 160 can more precisely apply the location criteria to locations of digital component requests.

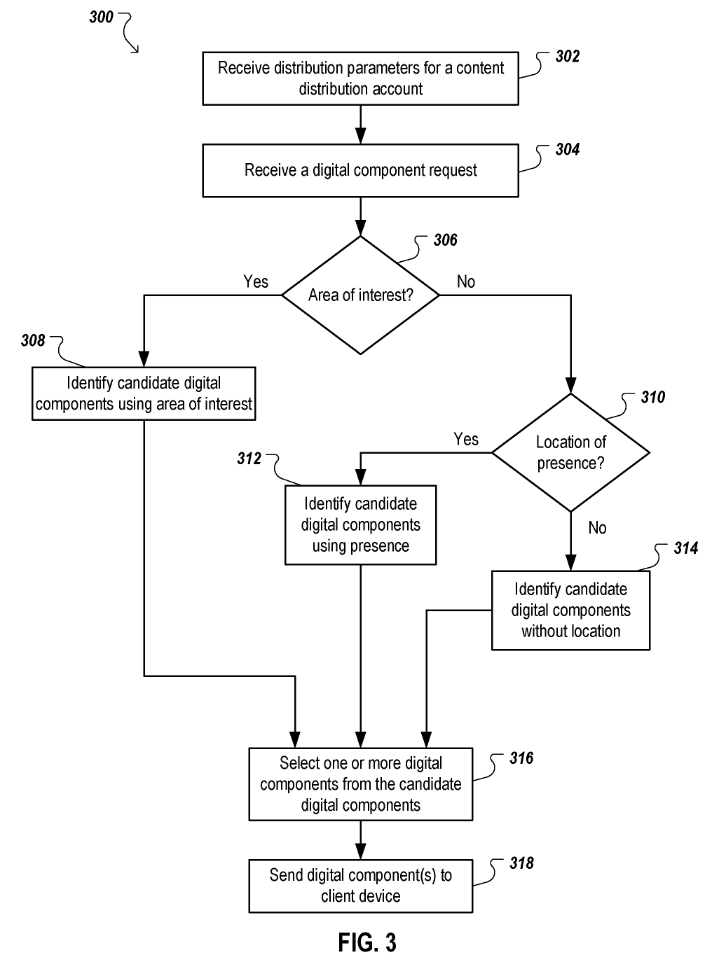

FIG. 3 is a flow chart of an example process 300 of selecting a digital component based on location information and sending the digital component to a client device. Operations of the process 300 can be performed, for example, by the service apparatus 110 of FIG. 1, or another data processing apparatus. The operations of the process 300 can also be implemented as instructions stored on a computer readable medium, which can be non-transitory. Execution of the instructions, by one or more data processing apparatus, causes the one or more data processing apparatus to perform operations of the process 300. For brevity, the process 300 is described in terms of being performed by a system.

The system receives distribution parameters for a content distribution account (302). The system can receive the distribution parameters from a digital component provider, e.g., via a user interface that enables the digital component provider to select or otherwise specify the distribution parameters (e.g., the user interface 200 of FIG. 2), via a file uploaded by the digital component provider, or via other ways.

In some implementations, the system is configured to determine distribution parameters for a content distribution account or account group based on information about the content distribution account or account group. For example, the system can use one or more AI models to evaluate the information to determine the distribution parameters. The information can include an item that is the subject of the content distribution account or account group, a landing page linked to the digital component(s), information about the digital component provider, the digital component(s) themselves, and/or other relevant information.

The distribution parameters can include location criteria at the content distribution account level and/or at the account group level. As described above, account level location criteria can apply to all digital components of the content distribution account, while account group level location criteria can apply to an account group in the content distribution account. The account group can include less than all of the digital components of the content distribution account.

The system receives a digital component request (304). The system can receive the component request from a client device of a user. As described above, the component request can include event data. The event data can describe a context in which a selected digital component will be presented (e.g., URL of electronic document with which the digital component will be presented, number of digital component slots, characteristics of the digital component slots, etc.), keywords (e.g., of queries or content of an electronic document), and/or information about the client device (e.g., an IP address, device identifier, etc.). Other event data can also be included.

The system determines whether the digital component includes an area of interest (306). As described above, the system can determine whether a digital component includes an area of interest based on keywords of the component request, contextual data of the component request, and/or disambiguation signals of the component request.

If the system determines that the digital component includes an area of interest, the system identifies candidate digital components using the area of interest (308). The system can identify, as candidate digital components, digital components for which the area of interest satisfies the location criteria of the account group that includes the digital component and/or its content distribution account. These digital components may have other distribution parameters that must also be satisfied to be eligible for selection. If an account group (or its content distribution account) has area of interest criteria that is not satisfied by the area of interest of the component request, the digital components of the account group may not be eligible for selection.

The system can also identify, as candidate digital components, digital components that do not have location criteria but for which their distribution parameters are satisfied. For example, there can be digital components that are not restricted to particular locations. If the other distribution parameters of these digital components are satisfied, the digital components can be considered candidate digital components that are eligible for selection.

In some implementations, the system may not include such digital components as candidates if the digital component includes an area of interest. For example, if the system is confident that the user is searching for information or other content in a particular area, the system may only include candidate digital components that have location criteria (e.g., area of interest criteria) that makes the digital component eligible in that particular area.

If the system determines that the component request does not include an area of interest, the system determines whether the component request includes a location of presence (310). As described above, some component requests include information indicating a location of presence. Additionally, the location of presence can be determined based on other signals, e.g., IP address, in some situations.

If the system determines that the component request includes a location of presence, the system identifies candidate digital components using the location of presence (312). The system can identify, as candidate digital components, digital components for which location criteria of its account group and/or the location criteria of its content distribution account is satisfied by the location of presence of the component request. Similar to the area of interest, the system can include or not include as candidates the digital components that do not have location criteria.

If the system determines that the digital component does not include a location of presence, the system identifies candidate digital components independent of location criteria (314). When a component request is not location specific by not having an area of interest or a location of presence, the system can identify the candidate digital components using other distribution parameters. However, in some implementations, digital components that have location criteria may not be eligible as candidate digital components since the location criteria for the digital components are not satisfied.

The system selects one or more digital components from the candidate digital components (316). As described above, digital components can be selected based on distribution parameters, which can include selection values. For example, the system can use the distribution parameters to identify the candidate digital components that are eligible to be provided in response to a component request, and then select one or more digital components from those candidate digital components based on the selection values for the candidate digital components and/or other parameters. The other parameters can include, for example, an expected performance of the candidate digital component, e.g., likelihood of the user interacting with (e.g., selecting) the candidate digital component or performing a specified action after viewing or interacting with the candidate digital component. For example, the system can select one or more digital components from the candidate digital components based on, for each candidate digital component, a combination of the selection value and the expected performance of the candidate digital component (e.g., a product of the selection value and the expected performance). For example, the system can select the candidate digital components that have the highest combination of selection value and expected performance.

The system sends digital component data for each of the one or more digital components to the client device (318). As described above, the digital component data for a digital component can cause a client device to present the digital component or at least enables the client device to present the digital component. In turn, the client device can present the digital component to the user.

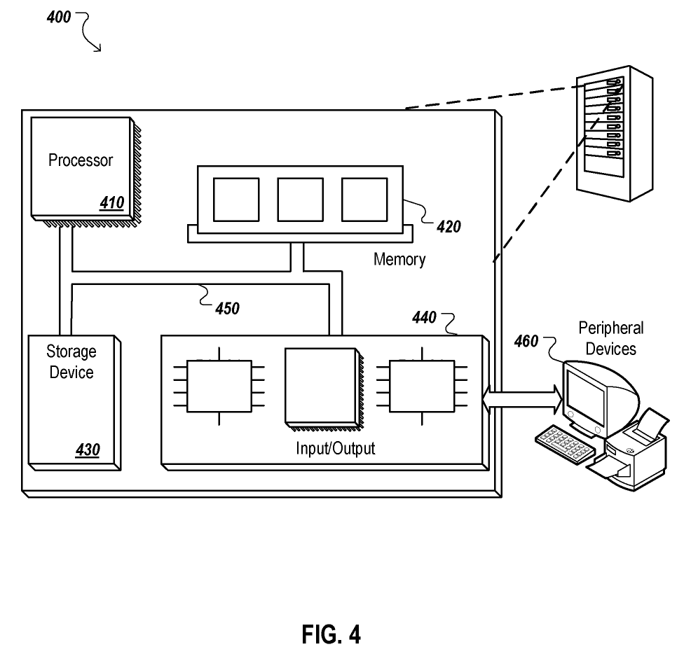

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, for a content distribution account comprising a set of digital components, distribution parameters for the set of digital components, wherein the distribution parameters comprise account-level distribution parameters comprising account-level location criteria for the set of digital components and account group-level distribution parameters comprising, for each of multiple subsets of digital components of the set of digital components, account group-level location criteria;
receiving, from a client device, a digital component request comprising one or more terms;
determining that the digital component request comprises an area of interest;
in response to determining that the digital component request comprises an area of interest, identifying a set of candidate digital components, including identifying, as a candidate digital component, at least one digital component in the set of digital components for which the area of interest satisfies the account group-level location criteria for a subset of digital components that includes the at least one digital component;
selecting, from the set of candidate digital components, one or more digital components to provide to the client device in response to the digital component request; and
sending the one or more digital components to the client device.

2. The method of claim 1, comprising:
receiving, from an additional client device, an additional digital component request comprising one or more additional terms;
determining that the additional digital component request does not include an area of interest; and
in response to determining that the additional digital component request does not include an area of interest, determining whether the additional digital component request indicates a location of presence of the additional client device.

3. The method of claim 2, comprising, in response to determining that the additional digital component request indicates the location of presence of the additional client device:
identifying an additional set of candidate digital components, including identifying, as an additional candidate digital component, at least one additional digital component in the set of digital components for which the location of presence satisfies both the account-level location criteria and the account group-level location criteria for a subset of digital components that includes the at least one additional digital component;
selecting, from the additional set of candidate digital components, one or more additional digital components to provide to the additional client device in response to the additional digital component request; and
sending the one or more additional digital components to the additional client device.

4. The method of claim 2, comprising, in response to determining that the additional digital component request does not indicate the location of presence of the additional client device:
identifying an additional set of candidate digital components, including identifying, as an additional candidate digital component, at least one digital component in the set of digital components that does not have location-based distribution parameters;
selecting, from the additional set of candidate digital components, one or more additional digital components to provide to the additional client device in response to the additional digital component request; and
sending the one or more additional digital components to the additional client device.

5. The method of claim 1, wherein determining that the digital component request comprises an area of interest comprises determining that the digital component request comprises an area of interest based at least on the one or more terms.

6. The method of claim 5, wherein determining that the digital component request comprises an area of interest comprises disambiguating between multiple geographic areas based on one or more additional signals, the one or more additional signals comprising a location of presence of the client device.

7. The method of claim 6, wherein the one or more additional signals comprise historical locations of the client device and/or a user of the client device.

8. The method of claim 7, wherein the one or more additional signals comprise, for each historical location a frequency at which the client device or the user of the client device has visited the historical location.

9. The method of claim 1, wherein determining that the digital component request comprises an area of interest comprises determining that the digital component request comprises an area of interest based at least on (i) the one or more terms, (ii) location history of the user, (iii) past searches of the user, or any combination of (i), (ii), and (iii).

10. A system comprising:
one or more processors; and
one or more storage devices storing instructions that, when executed by the one or more processors, cause the one or more processors to perform operations comprising:
receiving, for a content distribution account comprising a set of digital components, distribution parameters for the set of digital components, wherein the distribution parameters comprise account-level distribution parameters comprising account-level location criteria for the set of digital components and account group-level distribution parameters comprising, for each of multiple subsets of digital components of the set of digital components, account group-level location criteria;
receiving, from a client device, a digital component request comprising one or more terms;
determining that the digital component request comprises an area of interest;
in response to determining that the digital component request comprises an area of interest, identifying a set of candidate digital components, including identifying, as a candidate digital component, at least one digital component in the set of digital components for which the area of interest satisfies the account group-level location criteria for a subset of digital components that includes the at least one digital component;
selecting, from the set of candidate digital components, one or more digital components to provide to the client device in response to the digital component request; and
sending the one or more digital components to the client device.

11. The system of claim 10, wherein the operations comprise:
receiving, from an additional client device, an additional digital component request comprising one or more additional terms;
determining that the additional digital component request does not include an area of interest; and
in response to determining that the additional digital component request does not include an area of interest, determining whether the additional digital component request indicates a location of presence of the additional client device.

12. The system of claim 11, wherein the operations comprise, in response to determining that the additional digital component request indicates the location of presence of the additional client device:
identifying an additional set of candidate digital components, including identifying, as an additional candidate digital component, at least one additional digital component in the set of digital components for which the location of presence satisfies both the account-level location criteria and the account group-level location criteria for a subset of digital components that includes the at least one additional digital component;
selecting, from the additional set of candidate digital components, one or more additional digital components to provide to the additional client device in response to the additional digital component request; and
sending the one or more additional digital components to the additional client device.

13. The system of claim 11, wherein the operations comprise, in response to determining that the additional digital component request does not indicate the location of presence of the additional client device:
identifying an additional set of candidate digital components, including identifying, as an additional candidate digital component, at least one digital component in the set of digital components that does not have location-based distribution parameters;
selecting, from the additional set of candidate digital components, one or more additional digital components to provide to the additional client device in response to the additional digital component request; and
sending the one or more additional digital components to the additional client device.

14. The system of claim 10, wherein determining that the digital component request comprises an area of interest comprises determining that the digital component request comprises an area of interest based at least on the one or more terms.

15. The system of claim 14, wherein determining that the digital component request comprises an area of interest comprises disambiguating between multiple geographic areas based on one or more additional signals, the one or more additional signals comprising a location of presence of the client device.

16. The system of claim 15, wherein the one or more additional signals comprise historical locations of the client device and/or a user of the client device.

17. The system of claim 16, wherein the one or more additional signals comprise, for each historical location a frequency at which the client device or the user of the client device has visited the historical location.

18. The system of claim 10, wherein determining that the digital component request comprises an area of interest comprises determining that the digital component request comprises an area of interest based at least on (i) the one or more terms, (ii) location history of the user, (iii) past searches of the user, or any combination of (i), (ii), and (iii).

19. A non-transitory computer readable storage medium carrying instructions that, when executed by one or more processors, cause the one or more processors to perform operations comprising:
receiving, for a content distribution account comprising a set of digital components, distribution parameters for the set of digital components, wherein the distribution parameters comprise account-level distribution parameters comprising account-level location criteria for the set of digital components and account group-level distribution parameters comprising, for each of multiple subsets of digital components of the set of digital components, account group-level location criteria;
receiving, from a client device, a digital component request comprising one or more terms;
determining that the digital component request comprises an area of interest;
in response to determining that the digital component request comprises an area of interest, identifying a set of candidate digital components, including identifying, as a candidate digital component, at least one digital component in the set of digital components for which the area of interest satisfies the account group-level location criteria for a subset of digital components that includes the at least one digital component;
selecting, from the set of candidate digital components, one or more digital components to provide to the client device in response to the digital component request; and
sending the one or more digital components to the client device.

20. The non-transitory computer readable storage medium of claim 19, wherein the operations comprise:
receiving, from an additional client device, an additional digital component request comprising one or more additional terms;
determining that the additional digital component request does not include an area of interest; and
in response to determining that the additional digital component request does not include an area of interest, determining whether the additional digital component request indicates a location of presence of the additional client device.
